(19) United States
(12) Patent Application Publication
(10) Pub. No.: US 2026/0104207 A1
(43) Pub. Date: Apr. 16, 2026

(54) GAS COOLING APPARATUS AND HEAT FURNACE

(71) Applicant: LAPLACE Renewable Energy Technology Co., Ltd., Shenzhen (CN)

(72) Inventors: Aisuo Pang, Shenzhen (CN); Yongsheng Guo, Shenzhen (CN); Jiaji Lin, Shenzhen (CN); Wu Zhang, Shenzhen (CN)

(21) Appl. No.: 19/421,601

(22) Filed: Dec. 16, 2025

Related U.S. Application Data
(63) Continuation-in-part of application No. PCT/CN2024/099451, filed on Jun. 14, 2024.

(30) Foreign Application Priority Data
Jun. 16, 2023 (CN) 202310716600.7
Jun. 16, 2023 (CN) 202321541270.4

(51) Int. Cl. F27D 17/28; B01F 23/213; B01F 25/314; F23J 15/00; F23J 15/06; F27B 17/00; F28C 3/08

(52) U.S. Cl. CPC F27D 17/28; B01F 23/21321; B01F 25/31423; B01F 25/3143; F23J 15/003; F23J 15/06; F28C 3/08; F27B 17/0025

(57) ABSTRACT

The present application discloses a gas cooling apparatus and a heat furnace. The gas cooling apparatus comprises a pipeline structure. The pipeline structure defines a gas flow channel and a liquid channel; the gas flow channel is used for circulating a high-temperature gas; and the liquid channel is located outside the gas flow channel and is provided with a liquid spraying part communicated with the gas flow channel. The pipeline structure is further provided with a gas spraying part communicated with the gas flow channel; and a liquid sprayed from the liquid spraying part can be atomized under the action of the high-temperature gas in the gas flow channel and the high-pressure gas sprayed from the gas spraying part. The gas cooling apparatus has the advantages of simple structure, convenient use, rapid cooling rate for a high-temperature gas, and less use of a cooling liquid.

The present disclosure claims the priority of Chinese Patent Application No. 202321541270.4, filed with the China National Intellectual Property Administration on Jun. 16, 2023, and entitled “GAS COOLING APPARATUS”, all of which are incorporated herein by reference.

The present disclosure claims the priority of Chinese Patent Application No. 202310716600.7, filed with the China National Intellectual Property Administration on Jun. 16, 2023, and entitled “HEAT DISSIPATION APPARATUS”, all of which are incorporated herein by reference.

### TECHNICAL FIELD

The present disclosure relates to the field of semiconductor processing technology, and particularly, to a gas cooling apparatus and a heat furnace.

### BACKGROUND

Equipment used for processes such as photovoltaic deposition or diffusion includes a heat furnace. During operation of the heat furnace, an internal temperature can reach up to thousands of degrees Celsius. Gas discharged from the heat furnace needs to be cooled before being exhausted. Existing exhaust gas cooling structures typically involve wrapping cold-water pipes around exhaust pipelines to achieve exhaust gas cooling. However, this cooling method has poor efficiency, and the cold-water pipes are easily damaged by a high temperature of the exhaust pipelines, the cold-water pipes requires periodic inspection and replacement, which makes the maintenance of the exhaust gas cooling structures complicated and inconvenient to use.

Therefore, there is an urgent need for a gas cooling apparatus that can achieve rapid cooling and is convenient to use.

### SUMMARY

A first objective of the present disclosure is to provide a gas cooling apparatus and a heat furnace. The gas cooling apparatus has a simple structure, is convenient to use, provides a rapid cooling rate for high-temperature gas, and utilizes a smaller amount of cooling liquid.

To achieve the above technical effects, the technical solutions of the present disclosure are as follows:

The present disclosure discloses a gas cooling apparatus including a pipe structure. The pipe structure defines a gas flow channel and a liquid channel. The gas flow channel is configured for circulating a high-temperature gas. The liquid channel is located outside the gas flow channel and includes a liquid spraying part in communication with the gas flow channel. The pipe structure further includes a gas spraying part in communication with the gas flow channel. A liquid sprayed from the liquid spraying part is capable of vaporizing under a combined effect of the high-temperature gas in the gas flow channel and a high-pressure gas sprayed from the gas spraying part.

In some specific embodiments, the gas flow channel includes a high-temperature zone, and the high-temperature zone is located at an end of the gas flow channel close to an inflow direction of the high-temperature gas. The liquid channel includes a cooling channel and a liquid storage chamber. The cooling channel has a liquid inlet connectable to an external liquid source, and the cooling channel is located outside the high-temperature zone. The liquid storage chamber has a communication port and the liquid spraying part. The communication port is in communication with the cooling channel, and a flow area of the communication port is less than a flow area of each of the cooling channel and the liquid storage chamber.

In some specific embodiments, the gas cooling apparatus further includes a liquid inlet pipe. One end of the liquid inlet pipe is connected to the pipe structure and is in communication with the liquid inlet, and another end of the liquid inlet pipe is connectable to the external liquid source.

In some specific embodiments, the gas cooling apparatus further includes a guide pipe located within the cooling channel. The guide pipe is configured such that the cooling channel is substantially filled with the liquid before the liquid overflowing into a liquid storage chamber.

In some specific embodiments, an inlet of the guide pipe is in communication with the cooling channel, the inlet of the guide pipe is located at a gas inlet end of the gas flow channel, and an outlet of the guide pipe is in communication with the liquid storage chamber, such that the liquid in the cooling channel flows into the liquid storage chamber along the guide pipe.

In some specific embodiments, the guide pipe includes a first pipe section and a second pipe section. The first pipe section is in communication with the liquid channel, and the second pipe section is in communication with the liquid storage chamber. A connection position between the first pipe section and the second pipe section is higher than the gas inlet end of the gas flow channel.

In some specific embodiments, the guide pipe is a bent pipe. An inlet of the bent pipe is in communication with the liquid channel, an outlet of the bent pipe is in communication with the liquid storage chamber, and a bent portion of the bent pipe is higher than the gas inlet end of the gas flow channel.

In some specific embodiments, a number of the liquid spraying part is multiple, and the liquid spraying parts are spaced apart from each other along a circumferential direction of the gas flow channel.

In some specific embodiments, the gas spraying part is inclinedly arranged, and an extension direction of the liquid spraying part intersects with an extension direction of the gas spraying part.

In some specific embodiments, the pipe structure further defines a gas storage chamber. The gas storage chamber is connectable to an external gas source, and the gas spraying part is in communication with the gas storage chamber.

In some specific embodiments, along a gas flow direction within the gas flow channel, a flow area of the gas storage chamber gradually decreases, and the gas spraying part is arranged on an inclined sidewall of the gas storage chamber facing the gas flow channel.

In some specific embodiments, the gas cooling apparatus further includes a gas inlet pipe. One end of the gas inlet pipe is connected to the gas storage chamber, and another end is connected to an external high-pressure gas source.

In some specific embodiments, a number of the gas spraying part is multiple, and the gas spraying parts are spaced apart from each other along a circumferential direction of the gas flow channel.

In some specific embodiments, the gas flow channel includes the high-temperature zone, an atomization zone, and a vaporization zone arranged sequentially along a gas flow direction. A portion of the liquid channel is located outside the high-temperature zone, and each of the gas spraying part and the liquid spraying part is in communication with the atomization zone.

The present disclosure further discloses a gas cooling apparatus including a pipe structure. The pipe structure defines a gas flow channel and a liquid channel. The gas flow channel is configured for circulating a high-temperature gas. The liquid channel is located outside the gas flow channel and comprises a liquid spraying part in communication with the gas flow channel. The liquid spraying part is configured for spraying liquid to the gas flow channel.

In some specific embodiments, the gas flow channel has a gas inlet end and a gas outlet end, the gas inlet end is configured for inflowing the high-temperature gas, and the liquid channel has a liquid inlet. The liquid channel further includes a connection pipe. An outlet of the connection pipe is arranged at the gas outlet end, an inlet of the connection pipe is in communication with the liquid channel, and the outlet of the connection pipe is in communication with the gas flow channel to spray the liquid to the gas flow channel. The liquid spraying part is arranged at the outlet of the connection pipe, and the outlet of the connection pipe sprays liquid to the gas flow channel through the liquid spraying part.

In some specific embodiments, the gas flow channel is inclinedly arranged, and the gas inlet end is higher than the gas outlet end.

In some specific embodiments, the connection pipe includes a first pipe body and a second pipe body. The first pipe body is in communication with the liquid channel, the second pipe body is in communication with the gas flow channel, and a connection position between the first pipe body and the second pipe body is higher than the gas inlet end of the gas flow channel.

In some specific embodiments, the connection pipe further includes a third pipe body. One end of the third pipe body is connected to the first pipe body and another end of the third pipe body is connected to the second pipe body, and the third pipe body is higher than the gas inlet end of the gas flow channel.

In some specific embodiments, the connection pipe is a bent pipe. An inlet of the bent pipe is in communication with the liquid channel, an outlet of the bent pipe is in communication with the gas flow channel, and a bent portion of the bent pipe is higher than the gas inlet end of the gas flow channel.

In some specific embodiments, the gas cooling apparatus further includes a fan. The fan is arranged within the pipe structure to drive forced flow of a gas within the gas flow channel.

In some specific embodiments, the gas cooling apparatus further includes a suction pipe. One end of the suction pipe is connected to a gas outlet end of the gas flow channel, and another end of the suction pipe is configured for installing the fan. The end of the suction pipe for installing the fan is lower than the end of the suction pipe connected to the gas outlet end.

In some specific embodiments, the gas cooling apparatus further includes an exhaust pipe connected to a side of the fan opposite the suction pipe.

The present disclosure discloses a heat furnace including a furnace body and the gas cooling apparatus described above. The furnace body has an exhaust pipe. The gas cooling apparatus is configured for cooling gas released from the furnace body through the exhaust pipe.

Beneficial effects of the gas cooling apparatus of the present disclosure are as follows: Compared to the existing technical solutions of wrapping cold-water pipes around exhaust pipelines, the pipe structure of the high-temperature gas cooling apparatus of the present disclosure is connected to a gas outlet of the exhaust pipeline, which is simple to use, is not easily damaged by the exhaust pipeline, ensuring a long service life. During operation, after the high-temperature gas enters the gas flow channel, since the liquid channel is arranged outside the gas flow channel, the liquid channel can cool the high-temperature gas. The liquid in the liquid channel can also be sprayed from the liquid spraying part to the gas flow channel. The sprayed liquid under the high-pressure gas from the gas spraying part, in combination with the high-temperature gas, will sequentially vaporize. The vaporization of the liquid is capable of carrying away a large amount of heat. Since the gas cooling apparatus is capable of carrying away a large amount of heat through liquid cooling and liquid vaporization, it achieves rapid cooling of the high-temperature gas, improving the cooling rate and cooling efficiency. The provision of the gas spraying part sprays high-pressure gas to the gas flow channel to atomize the liquid sprayed into the gas flow channel, allows for full utilization of the sprayed liquid for cooling the high-temperature gas, reducing the amount of sprayed liquid used. Since the liquid channel is arranged outside the gas flow channel, the structural material of the entire pipe can be a conventional material, without the need for special high-temperature resistant materials, thereby reducing the manufacturing cost of the gas cooling apparatus.

Additional aspects and advantages of the present disclosure will be set forth in part in the description which follows, and in part will be apparent from the description, or may be learned by practice of the present disclosure.

### BRIEF DESCRIPTION OF THE DRAWINGS

FIG. 1 is a schematic cross-sectional view of a gas cooling apparatus according to an embodiment of the present disclosure;

FIG. 2 is an enlarged view of portion I in FIG. 1;

FIG. 3 is a schematic structural view of the gas cooling apparatus according to an embodiment of the present disclosure;

FIG. 4 is a cross-sectional view of part of the gas cooling apparatus according to an embodiment of the present disclosure;

FIG. 5 is a schematic internal structural view of the gas cooling apparatus according to an embodiment of the present disclosure;

FIG. 6 is a perspective structural view of the gas cooling apparatus according to an embodiment of the present disclosure;

FIG. 7 is a cross-sectional view of the gas cooling apparatus shown in FIG. 6;

FIG. 8 is a cross-sectional view of part of the gas cooling apparatus shown in FIG. 6;

FIG. 9 is a block diagram of a heat furnace according to an embodiment of the present disclosure.

Reference Numerals in the Drawings are as follows:
1: heat furnace; 100: gas cooling apparatus; 200: furnace body;
10: pipe structure; 11: gas flow channel; 111: high-temperature zone; 112: atomization zone; 1121: converging section; 1122: straight section; 113: vaporization zone; 114: gas inlet end; 115: gas outlet end; 12: liquid channel; 121: cooling channel; 1211: liquid inlet; 1212: first section; 1213: second section; 122: liquid storage chamber; 1221: communication port; 13: liquid spraying part; 14: gas spraying part; 15: gas storage chamber;
20: liquid inlet pipe;
30: guide pipe; 31: first pipe section; 32: second pipe section; 33: inlet;
40: gas inlet pipe;
50: connection pipe; 51: first pipe body; 52: second pipe body; 53: third pipe body;
60: fan;
70: suction pipe;
80: exhaust pipe.

### DETAILED DESCRIPTION OF THE EMBODIMENTS

To make the technical problems to be solved, the technical solutions, and the beneficial effects of the present disclosure clearer, the present disclosure will be further described in detail below with reference to the accompanying drawings and embodiments. It should be understood that the specific embodiments described herein are only for explaining the present disclosure and are not intended to limit the present disclosure.

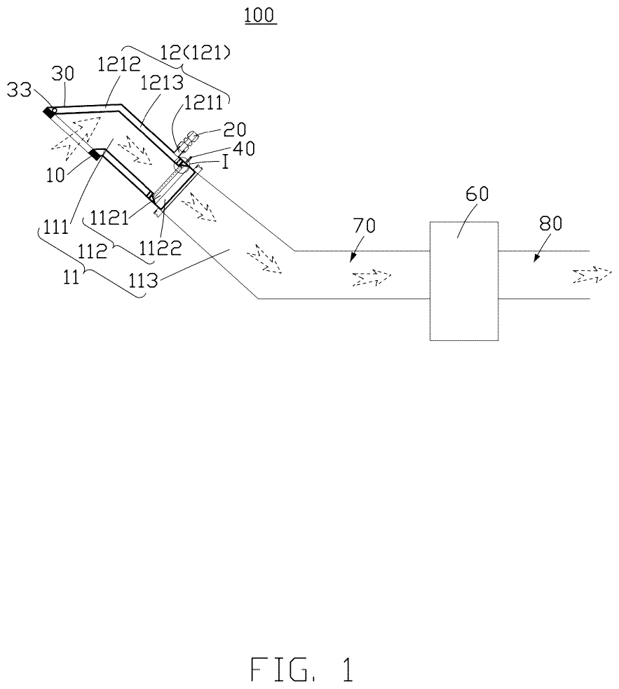

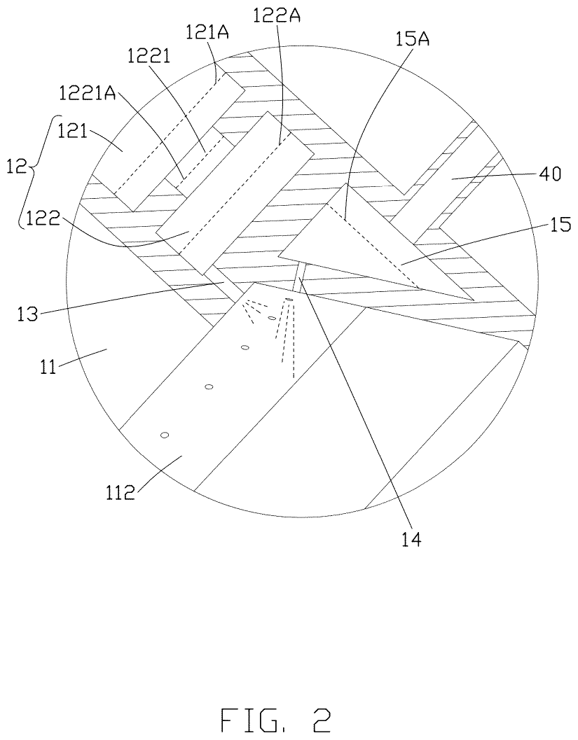

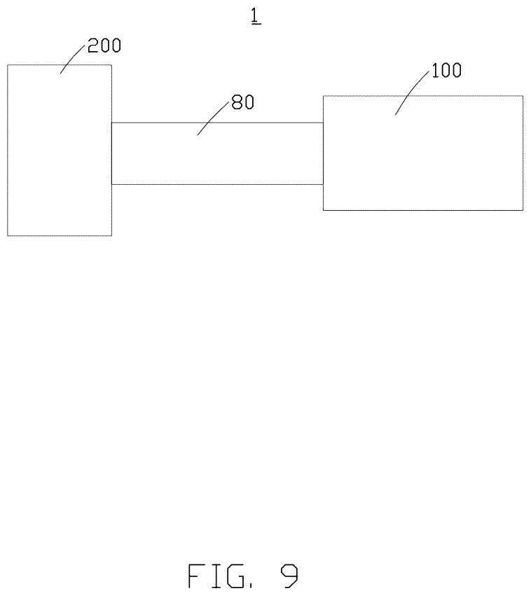

The present disclosure discloses a gas cooling apparatus 100. As shown in FIG. 1, FIG. 2, and FIG. 9, the gas cooling apparatus 100 includes a pipe structure 10. The pipe structure 10 defines a gas flow channel 11 and a liquid channel 12. The gas flow channel 11 is for circulating high-temperature gas. The liquid channel 12 is located outside the gas flow channel 11 and has a liquid spraying part 13 in communication with the gas flow channel 11. The pipe structure 10 also has a gas spraying part 14 in communication with the gas flow channel 11. Liquid sprayed from the liquid spraying part 13 is capable of vaporizing under the action of the high-temperature gas in the gas flow channel 11 and high-pressure gas sprayed from the gas spraying part 14.

First, it should be noted that, taking the liquid in the liquid channel 12 being water as an example, the specific heat capacity of water is 4.2 J/(g·° C.), and its latent heat of vaporization at 100° C. is 2257.2 kJ/kg. Therefore, during the vaporization phase change, the absorbed thermal energy is far greater than that in conventional water-cooling solutions.

It can be understood that the term “high temperature” in “high-temperature gas” and the term “high pressure” in “high-pressure gas” as described in the embodiments of the present disclosure refer to meanings generally understood by those skilled in the art, and do not impose specific numerical limits on the temperature and pressure of the gas.

It can be understood that, in actual use, the pipe structure 10 is connected to an exhaust pipe of the heat furnace 1. After the high-temperature gas enters the gas flow channel 11, since the liquid channel 12 is arranged outside the gas flow channel 11, the liquid channel 12 can cool the high-temperature gas. The liquid in the liquid channel 12 can further be sprayed from the liquid spraying part 13 to the gas flow channel 11. The sprayed liquid will rapidly atomize when encountering the high-pressure gas sprayed from the gas spraying part 14. The atomized liquid will then mix with the high-temperature gas. Upon encountering the high-temperature gas, the atomized liquid rapidly vaporizes, turning into steam. When the liquid vaporizes, a large amount of heat is absorbed, thereby ensuring that the temperature of the high-temperature gas drops rapidly, and the high-temperature gas will have a low temperature when discharged from the pipe structure 10.

It should be further noted that the atomization process and the vaporization process may not be in a strictly sequential order. The sprayed liquid may be atomized under the action of the high-pressure gas and then vaporized under the action of the high-temperature gas, or the sprayed liquid may vaporize directly under the combined action of the high-pressure gas and the high-temperature gas. In actual operation, the phase change process of the liquid may be quite complex, and the separation of the atomization and vaporization processes is for ease of description.

Compared to the existing technical solutions of wrapping cold-water pipes around an exhaust pipeline, the pipe structure 10 of the present disclosure is connected to the gas outlet of the exhaust pipeline, which is convenient to use, and not easily damaged by the exhaust pipeline, and has a long service life. During operation, a large amount of heat can be carried away through liquid cooling and liquid vaporization, achieving rapid cooling of the high-temperature gas and improving the cooling rate and cooling efficiency. The provision of the gas spraying part 14, which can spray high-pressure gas to the gas flow channel 11 to atomize the liquid sprayed into the gas flow channel 11, allows for full utilization of the sprayed liquid for cooling the high-temperature gas, reducing the amount of sprayed liquid used.

It should be additionally noted that since the liquid channel 12 is arranged outside the gas flow channel 11. The presence of the liquid channel 12, on one hand, ensures that the outer pipe temperature of the pipe structure 10 remains relatively safe, as the outer wall temperature cannot exceed the boiling point of water. On the other hand, the presence of the liquid channel 12 lowers the inner pipe temperature of the pipe structure 10, allowing the material of the pipe structure 10 to be conventional stainless-steel, without the need for special heat-resistant materials, thereby reducing the manufacturing cost of the gas cooling apparatus 100, ensuring the sealing characteristics of the gas cooling apparatus 100 and preventing liquid leakage.

Optionally, in actual operation, each the liquid channel 12 and the gas flow channel 11 can be multi-layered. For example, in some embodiments, the pipe structure 10 is a three-layer structure, where the middle layer is the gas flow channel 11, and each of the inner and outer layers is the liquid channel 12. Each of the outermost and innermost liquid channels 12 can spray liquid into the gas flow channel 11. The gas spraying part 14 is arranged at the position of the outermost liquid channel 12 of the pipe structure 10 and is isolated from the liquid channel 12, so as to spray external gas into the gas flow channel 11. Of course, in other embodiments of the present disclosure, the number of layers of the liquid channel 12 and the gas flow channel 11 can be selected according to actual needs.

Optionally, the gas spraying part 14 is a gas spraying hole, which allows the gas sprayed from the gas spraying part 14 to have a relatively high pressure, and is conducive to liquid atomization. In one embodiment, the cross-sectional shape of the gas spraying hole can be selected according to actual needs, and no limitation is made on the cross-sectional shape of the gas spraying hole herein.

Optionally, the liquid spraying part 13 is a liquid spraying hole, which allows the liquid sprayed from the liquid spraying part 13 to have a relatively high flow velocity, and is conducive to liquid atomization. In one embodiment, the cross-sectional shape of the liquid spraying hole can be selected according to actual needs, and no limitation is made on the cross-sectional shape of the liquid spraying hole herein.

In some embodiments, as shown in FIG. 1 and FIG. 2, the gas flow channel 11 includes a high-temperature zone 111, an atomization zone 112, and a vaporization zone 113 arranged sequentially along a gas flow direction. A portion of the liquid channel 12 is located outside the high-temperature zone 111, and each of the gas spraying part 14 and the liquid spraying part 13 is in communication with the atomization zone 112.

It can be understood that when the high-temperature gas flows through the high-temperature zone 111, it can be cooled by the cooling liquid in the liquid channel 12. When the high-temperature gas moves to the atomization zone 112, it can come into contact with the liquid droplets atomized by the high-pressure gas. In the vaporization zone 113, it can fully contact the atomized liquid, causing the atomized droplets to rapidly vaporize to cool the high-temperature gas.

In some specific embodiments, as shown in FIG. 1 and FIG. 2, the liquid channel 12 includes a cooling channel 121 and a liquid storage chamber 122. The cooling channel 121 has a liquid inlet 1211. The liquid inlet 1211 is connected to an external liquid source (not shown), and the cooling channel 121 is located outside the high-temperature zone 111. The liquid storage chamber 122 has a communication port 1221 and the liquid spraying part 13. The communication port 1221 is in communication with the cooling channel 121, and the flow area 1221A of the communication port 1221 is less than the flow area121A of the cooling channel 121 and the flow area 122A of the liquid storage chamber 122.

It can be understood that when the high-temperature gas flows through the high-temperature zone 111, it can be cooled by the cooling liquid in the cooling channel 121 thereby achieving cooling of the high-temperature gas through heat exchange, which is beneficial for improving the cooling rate. The cooling liquid enters the liquid storage chamber 122 from the cooling channel 121 before being sprayed. Since the flow area of the communication port 1221 is less than the flow area of each of the cooling channel 121 and the liquid storage chamber 122, the cooling liquid can have a greater pressure after entering the liquid storage chamber 122, causing the liquid sprayed to the gas flow channel 11 through the liquid spraying part 13 to have a higher pressure, thereby facilitating atomization.

In some specific embodiments, the cooling channel 121 is located at an upstream position of the pipe structure 10. Thus, the high-temperature gas can first be cooled by the cooling liquid in the liquid channel 12 within the pipe structure 10, and then further cooled by the atomized liquid, which can better improve the cooling effect on the high-temperature gas.

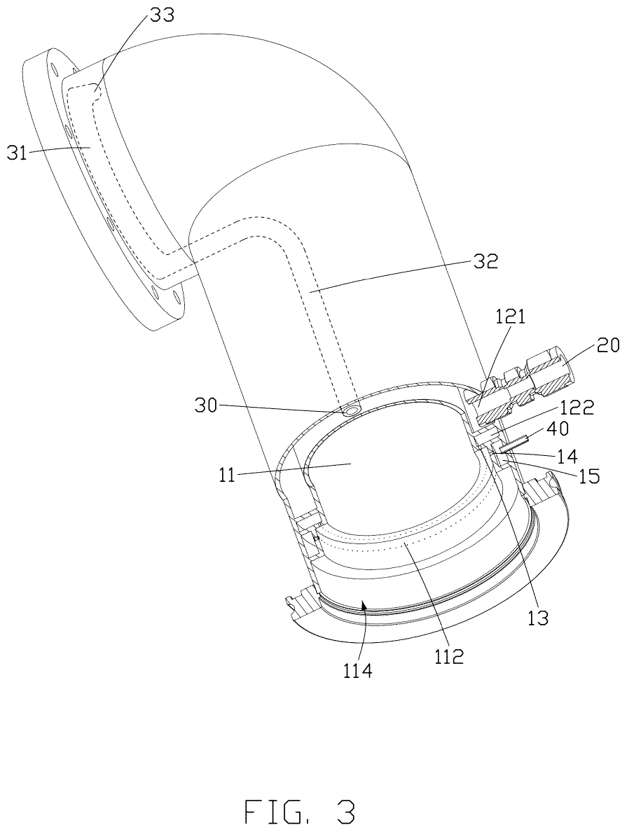

In some specific embodiments, as shown in FIG. 1 and FIG. 3, the gas cooling apparatus 100 further includes a guide pipe 30, the guide tube 30 being located within the cooling channel 121. The guide pipe 30 is configured to cause the liquid in the cooling channel 121 to substantially fill the cooling channel 121 before flowing into the liquid storage chamber 122. This helps to ensure that the cooling channel 121 remains filled with liquid, so that when the high-temperature gas flows into the pipe structure 10, it can first be cooled by the cooling liquid in the liquid channel 12.

It should be noted that by arranging the guide pipe 30 within the cooling channel 121, not only can the guide pipe 30 be protected, reducing the risk of damage to the guide pipe 30 due to impact, but also the structure of the gas cooling apparatus 100 is made more compact, reducing the overall space occupied by the gas cooling apparatus 100 and facilitating its use.

Of course, in other embodiments, the guide pipe 30 can be arranged on an outer wall of the pipe structure 10. The present disclosure does not limit this, and those skilled in the art can select according to the actual circumstances.

In some specific embodiments, an inlet 33 of the guide pipe 30 is in communication with the cooling channel 121, and the inlet 33 of the guide pipe 30 is located at an end of the high-temperature zone 111 away from the atomization zone 112. An outlet of the guide pipe 30 is in communication with the liquid storage chamber 122, such that the liquid in the cooling channel 121 flows into the liquid storage chamber 122 along the guide pipe 30.

In some specific embodiments, the guide pipe 30 includes a first pipe section 31 and a second pipe section 32. The first pipe section 31 is in communication with the liquid channel 12, and the second pipe section 32 is in communication with the liquid storage chamber 122. A connection position between the first pipe section 31 and the second pipe section 32 is higher than a gas inlet end 114 of the gas flow channel 11. It can be understood that the guide pipe 30 including the first pipe section 31 and the second pipe section 32 facilitates the connection of the guide pipe 30 to the liquid channel 12 and the liquid storage chamber 122. The fact that the connection position between the first pipe section 31 and the second pipe section 32 is higher than the gas inlet end 114 of the gas flow channel 11 can, to some extent, increase the pressure of the liquid flowing from the second pipe section 32 into the liquid storage chamber 122, increase the total amount of liquid, thereby increasing the contact between the high-temperature gas and the liquid, and accelerating the cooling efficiency.

It is worth noting that the highest point of the guide pipe 30 (i.e., the connection location between the first pipe section 31 and the second pipe section 32) is higher than the gas inlet end 114 of the gas flow channel 11. When the liquid passes through the pipe structure 10, since the highest point of the guide pipe 30 is higher than the highest point of the multi-layer pipe structure, it ensures that the liquid fills the multi-layer pipe structure and can be stably sprayed into the gas flow channel 11, thereby ensuring the cooling effect.

In some specific embodiments, a part of the cooling channel 121 can serve as a part of the guide pipe 30. For example, a part of the cooling channel 121 acts as the first pipe section 31 of the guide pipe 30. This can reduce the use of the guide pipe 30 and lower manufacturing costs.

In some specific embodiments, the guide pipe 30 is a bent pipe. An inlet 33 of the bent pipe is in communication with the liquid channel 12, an outlet of the bent pipe is in communication with the liquid storage chamber 122, and a bent portion of the bent pipe is higher than the gas inlet end 114 of the gas flow channel 11. It can be understood that the highest point of the guide pipe 30 (the bent portion) is higher than the gas inlet end 114 of the gas flow channel 11. When the liquid passes through the pipe structure 10, because the highest point of the guide pipe 30 is higher than the gas inlet end 114 of the gas flow channel 11, it ensures that the liquid fills the liquid channel 12 and can stably flow into the liquid storage chamber 122, thereby ensuring the cooling effect. At the same time, manufacturing the guide pipe 30 by bending a straight pipe facilitates the manufacturing of the guide pipe 30.

In some more specific embodiments, as shown in FIG. 1, the cooling channel 121 has a bent portion (not shown). The cooling channel 121 includes a first section 1212 and a second section 1213 arranged at an angle. The first section 1212 is upstream of the second section 1213. The first section 1212 intersects with an extension direction of the gas flow channel 11, and the second section 1213 is arranged parallel to the extension direction of the gas flow channel 11.

It can be understood that, in actual operation, after the high-temperature gas enters the gas flow channel 11, since the first section 1212 intersects with the extension direction of the gas flow channel 11, the high-temperature gas can be guided by the first section 1212 to enter the second section 1213. This is conducive to the contact between the high-temperature gas in the gas flow channel 11 and the cooling liquid in the cooling channel 121, thereby facilitating the cooling of the high-temperature gas.

In some more specific embodiments, the liquid inlet 1211 of the cooling channel 121 is located downstream of the second section 1213. It can be understood that the position of the liquid inlet 1211 can ensure that when the liquid spraying part 13 sprays liquid to the gas flow channel 11, the liquid has a greater pressure, which facilitates liquid atomization for cooling the high-temperature gas.

In some embodiments, the inlet 33 of the guide pipe 30 is arranged on the first section 1212. It can be understood that the inlet 33 of the guide pipe 30 serves as a liquid replenishment port. By disposing the inlet 33 of the guide pipe 30 on the first section 1212, on one hand, it can ensure that the cooling liquid almost fills the cooling channel 121 before flowing into the liquid storage chamber 122. Thus, the high-temperature gas can be cooled by the cooling liquid in the cooling channel 121, in coordination with cooling by the atomized cooling liquid, which can better improve the cooling effect on the high-temperature gas. On the other hand, it can ensure that there is sufficient cooling liquid in the cooling channel 121, which is beneficial for cooling the high-temperature gas.

In some specific embodiments, as shown in FIG. 2, the liquid spraying part 13 is arranged on a sidewall of the liquid storage chamber 122 that faces the gas flow channel 11. This allows the liquid sprayed from the liquid spraying part 13 to be as close as possible to the high-temperature gas in the gas flow channel 11, thereby facilitating the cooling of the high-temperature gas.

In some specific embodiments, the pipe structure 10 has a first pipe segment (not shown) and a second pipe segment (not shown). The first pipe segment forms the liquid channel 12 and the high-temperature zone 111 and atomization zone 112 of the gas flow channel 11. The second segment forms the vaporization zone 113 of the gas flow channel 11. The first pipe segment and the second pipe segment are connected by a flange.

It can be understood that the liquid channel 12 is on the outside, and the high-temperature zone 111 and atomization zone 112 of the gas flow channel 11 are on the inside, which means that the pipe structure 10 needs to be a multi-layer structure at the location of the first pipe segment, while the pipe structure 10 can be a single-layer pipe at the location of the second pipe segment. Dividing the pipe structure 10 into a first pipe segment and a second pipe segment facilitates the manufacturing of the pipe structure 10 and the assembly of the pipe structure 10.

In some specific embodiments, as shown in FIG. 1 and FIG. 2, the atomization zone 112 includes a converging section 1121 and a straight section 1122, which is more conducive to the atomization of the sprayed liquid under the action of the sprayed gas.

In some specific embodiments, a flow area of a small end of the converging section 1121 of the atomization zone 112 is greater than a flow area of the high-temperature zone 111. Thus, when the high-temperature gas flows from the high-temperature zone 111 to the atomization zone 112, it will form a jet-like gas flow. This type of flow has more sufficient contact with the atomized liquid, thereby facilitating the cooling of the high-temperature gas.

It should be further noted that from the high-temperature zone 111 to the atomization zone 112 and then to the vaporization zone 113, the flow area for the gas gradually increases. On one hand, this provides more space for the high-temperature gas to dissipate heat. On the other hand, the high-temperature gas exhibits a jet-like state, which facilitates more sufficient contact with the atomized liquid, thereby being more conducive to the cooling of the high-temperature gas.

In some specific embodiments, the atomization zone 112 is entirely a straight section 1122, to ensure that the high-temperature gas flows at a uniform speed, reduce the occurrence of turbulence in the high-temperature gas within the atomization zone 112, and mitigate the risk of reduced cooling effect.

In some more specific embodiments, as shown in FIG. 1 to FIG. 4, the gas cooling apparatus 100 further includes a liquid inlet pipe 20. The liquid inlet pipe 20 is connected to the pipe structure 10 and is in communication with the liquid inlet 1211. Thus, liquid from an external cold source can enter the liquid channel 12 from the liquid inlet 1211 through the liquid inlet pipe 20. The liquid inlet 1211 is located downstream of the second section 1213, ensuring that there is always sufficient liquid in the liquid channel 12 during the entire working process, which is beneficial for continuously spraying liquid to the gas flow channel 11.

In other more specific embodiments, the liquid inlet pipe 20 and the liquid inlet 1211 connected thereto can be located at an upstream position of the pipe structure 10, and the liquid spraying part 13 is located at a downstream position of the pipe structure 10. It can be understood that since the liquid inlet pipe 20 is located at the upstream position of the pipe structure 10, the liquid channel 12 always has sufficient liquid during the entire working process. The high-temperature gas can first be cooled by the cooling liquid in the liquid channel 12 within the pipe structure 10, and then be cooled by the atomized liquid, which can better improve the cooling effect on the high-temperature gas.

In some embodiments, as shown in FIG. 1, the pipe structure 10 includes a bent structure (not shown) located at the connection position between the first section 1212 and the second section 1213. A gas inlet direction and a gas outlet direction of the pipe structure 10 are arranged at an angle. Compared to a straight pipe, the pipe structure 10 of the embodiment has a bent structure, which allows the pipe structure 10 to reduce its total length in a certain direction while ensuring a long gas flow path, thereby facilitating the use of the pipe structure 10.

The embodiments of the present disclosure do not limit the specific shape of the bent structure of the pipe structure 10. In one possible scenario, the bent portion of the pipe structure 10 can adopt the manner shown in FIG. 1 to form a sharp corner at the connection position between the first section 1212 and the second section 1213. In another possible scenario, the bent portion of the pipe structure 10 can adopt a smooth transition manner to form a certain curvature at the connection position between the first section 1212 and the second section 1213.

In some specific embodiments, as shown in FIG. 2 and FIG. 3, the liquid spraying part 13 is arranged to extend along the gas flow direction within the gas flow channel 11, the gas spraying part 14 is inclinedly arranged, and an extension direction of the liquid spraying part 13 intersects with an extension direction of the gas spraying part 14. It can be understood that the inclined arrangement of the gas spraying part 14 causes the gas sprayed into the gas flow channel 11 to generate angular momentum, which can form a swirling vortex. The swirling vortex can increase the contact area between the high-pressure gas and the liquid, improve the atomization efficiency of the liquid, and thus facilitate improving the cooling efficiency of the high-temperature gas.

In some specific embodiments, as shown in FIG. 2, along the gas flow direction within the gas flow channel 11, a flow area 15A of the gas storage chamber 15 gradually decreases, and the gas spraying part 14 is arranged on an inclined sidewall of the gas storage chamber 15 facing the gas flow channel 11. It can be understood that the inner wall of the gas storage chamber 15 is formed as an inclined sidewall (for example, a cross-section of the gas storage chamber 15 is triangular, and the inclined sidewall is the hypotenuse of the triangle), which can, to a certain extent, increase the angular momentum generated by the gas sprayed into the gas flow channel 11, making the vortex more intense, further increasing the contact area between the high-pressure gas and the liquid, further improving the atomization efficiency of the liquid, and thus facilitating improving the cooling efficiency of the high-temperature gas.

In other embodiments, the gas storage chamber 15 can also adopt other shapes, for example, the cross-section of the gas storage chamber 15 is a rectangle. It is only necessary to ensure that the gas spraying part 14 is arranged to face the gas flow channel 11 and that the extension direction of the gas spraying part 14 intersects with the extension direction of the liquid spraying part 13. The present disclosure does not limit this.

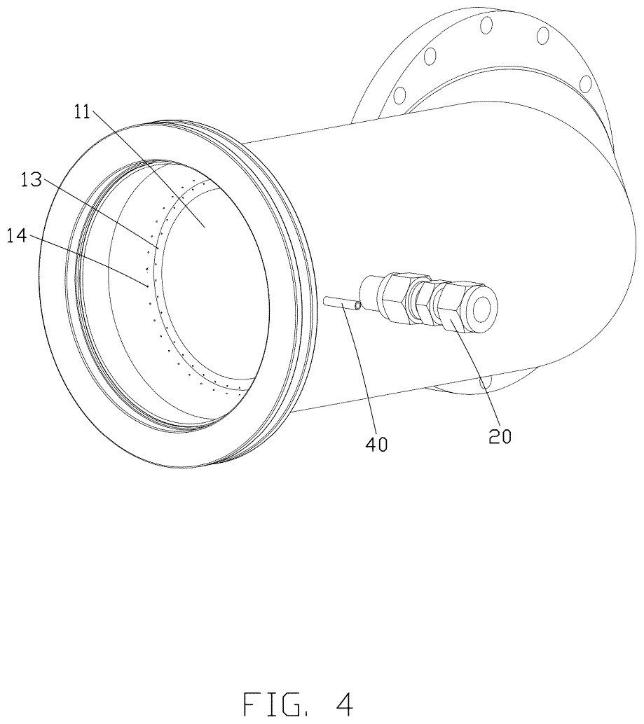

In some specific embodiments, as shown in FIG. 1, FIG. 3, and FIG. 4, the gas cooling apparatus 100 further includes a gas inlet pipe 40. One end of the gas inlet pipe 40 is connected to the gas storage chamber 15, and another end of the gas inlet pipe 40 is connected to an external high-pressure gas source. This facilitates the supply of gas to the pipe structure 10.

In some specific embodiments, a number of the liquid spraying part 13 is multiple, and the liquid spraying parts 13 are spaced apart from each other along a circumferential direction of the gas flow channel 11. It can be understood that the multiple liquid spraying parts 13 being circumferentially spaced apart along the gas flow channel 11 allows the liquid to be uniformly sprayed into the gas flow channel 11, which is beneficial for increasing the contact area between the high-temperature gas and the liquid, thereby facilitating an increase in the cooling rate.

In some specific embodiments, the number of the liquid spraying part 13 is multiple, and the liquid spraying parts 13 are spaced apart from each other along a axial direction of the gas flow channel 11. This allows the liquid to be uniformly sprayed into the gas flow channel 11, which is beneficial for increasing the contact area between the high-temperature gas and the liquid, thereby facilitating an increase in the cooling rate.

It should be noted that in actual design, the liquid spraying parts 13 can be arranged in multiple rings along the gas flow channel 11, with each ring having multiple liquid spraying parts 13 spaced apart from each other along the circumferential direction of the gas flow channel 11. The distribution of the liquid spraying parts 13 can be selected according to actual needs.

In some specific embodiments, the size of the liquid spraying part 13 is less than 1 mm. Thus, the liquid sprayed from the liquid spraying part 13 has a high pressure, which is conducive to the atomization of the liquid under the action of the high-pressure gas. It should be further noted here that the shape and size of the liquid spraying part 13 can be selected according to actual needs and are not limited to the above limitation.

In some specific embodiments, the liquid spraying part 13 is formed as an elongated slot-shaped hole. This can further increase the pressure of the liquid sprayed from the liquid spraying part 13, which is conducive to the atomization of the liquid under the action of the high-pressure gas.

In some specific embodiments, as shown in FIG. 4, a number of the gas spraying part 14 is multiple, and the gas spraying parts 14 are spaced apart from each other along the circumferential direction of the gas flow channel 11. It can be understood that the multiple gas spraying parts 14 being circumferentially spaced apart along the gas flow channel 11 allows the high-pressure gas to be uniformly sprayed into the gas flow channel 11, which is beneficial for increasing the contact area between the high-pressure gas and the liquid, facilitating the atomization of the liquid sprayed into the gas flow channel 11, and thereby facilitating an increase in the cooling rate.

In some specific embodiments, the number of the gas spraying parts 14 is multiple, and the gas spraying parts 14 are spaced apart from each other along the axial direction of the gas flow channel 11. This allows the high-pressure gas to be uniformly sprayed into the gas flow channel 11, which is beneficial for increasing the contact area between the high-pressure gas and the liquid, facilitating the atomization of the liquid sprayed into the gas flow channel 11, and thereby facilitating an increase in the cooling rate.

It should be noted that, in actual design, the gas spraying parts 14 can be arranged in multiple rings along the gas flow channel 11, with each ring having multiple gas spraying parts 14 spaced apart from each other along the circumferential direction of the gas flow channel 11. The distribution of the gas spraying parts 14 can be selected according to actual needs.

In some specific embodiments, the aperture of the gas spraying part 14 is less than 1 mm. Thus, the gas sprayed from the gas spraying part 14 has a high pressure, which is conducive to the atomization of the liquid. It should be further noted here that the shape and size of the gas spraying part 14 can be selected according to actual needs and are not limited to the above limitation.

It should be further noted here that in the embodiments of the present disclosure, the distribution forms of the gas spraying part 14 and the liquid spraying part 13 can be arbitrarily combined according to actual needs. For example, in some embodiments, there are multiple rings of gas spraying parts 14 and multiple rings of liquid spraying parts 13. In another example, in some embodiments, the gas spraying parts 14 and the liquid spraying parts 13 are each in a single ring.

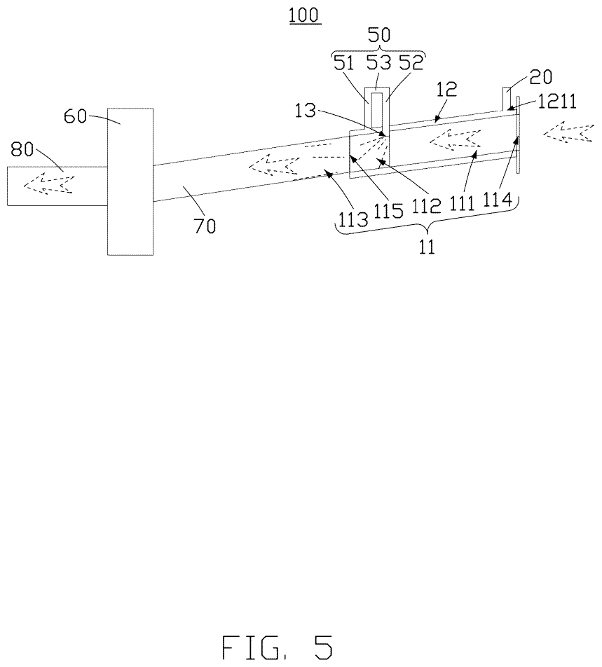

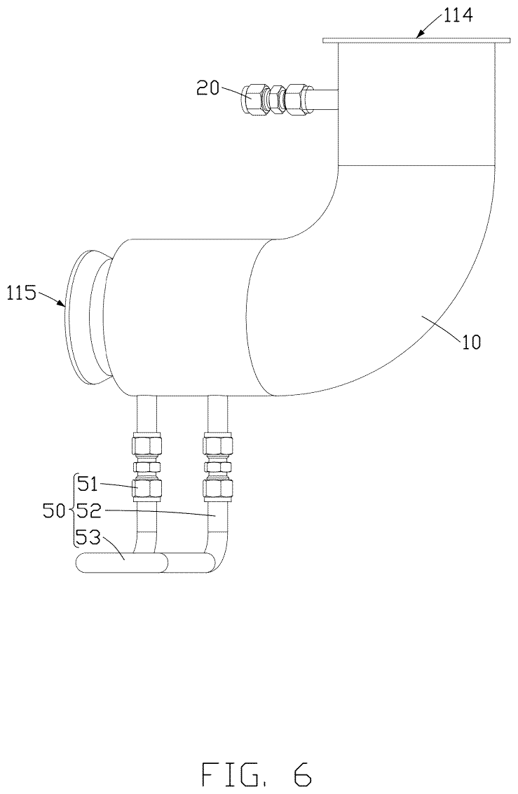

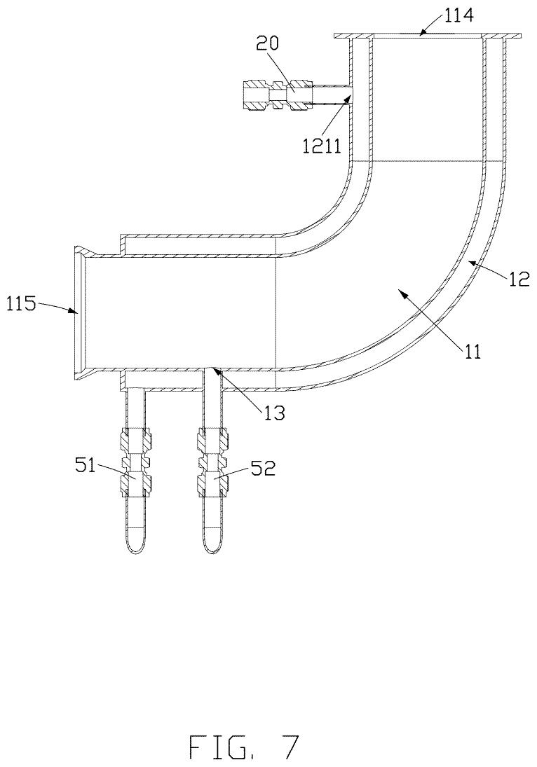

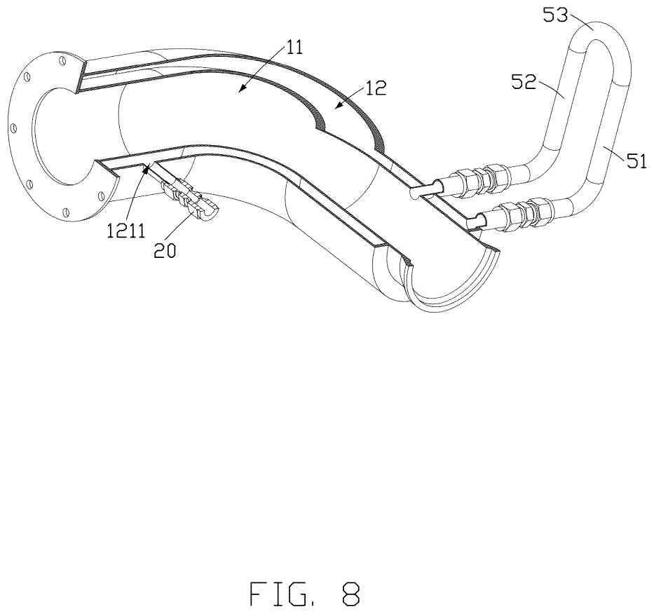

An embodiment of the present disclosure also provides a gas cooling apparatus 100, as shown in FIG. 5 to FIG. 8. The gas cooling apparatus 100 includes a pipe structure 10. The pipe structure 10 defines a gas flow channel 11 and a liquid channel 12. The gas flow channel 11 is configured for circulating high-temperature gas. The liquid channel 12 is located outside the gas flow channel 11 and has a liquid spraying part 13 in communication with the gas flow channel 11. The liquid spraying part 13 is configured for spraying liquid to the gas flow channel 11.

Specifically, the gas flow channel 11 has a gas inlet end 114 and a gas outlet end 115. The gas inlet end 114 is configured for inflowing high-temperature gas. The liquid channel 12 has a liquid inlet 1211. The liquid channel 12 further includes a connection pipe 50. An outlet of the connection pipe 50 is arranged at the gas outlet end 115. An inlet of the connection pipe 50 is in communication with the liquid channel 12. The outlet of the connection pipe 50 is in communication with the gas flow channel 11 to spray liquid to the gas flow channel 11. Wherein, the liquid spraying part 13 is arranged at the outlet of the connection pipe 50, and the outlet of the connection pipe 50 sprays liquid to the gas flow channel 11 through the liquid spraying part 13.

It can be understood that with the gas cooling apparatus 100 of this embodiment, when liquid is sprayed from the outlet of the connection pipe 50 to the gas flow channel 11, most of the liquid will rapidly vaporize upon encountering the high-temperature gas. During the vaporization process, a large amount of heat is absorbed. Thus, the heat carried by the high-temperature gas is largely consumed during the liquid vaporization process, rapidly achieving cooling of the high-temperature gas. Compared to the conventional cooling method of water-cooling heat exchange, this embodiment utilizes the principle that a large amount of heat is absorbed when a liquid changes from a liquid phase to a gas phase, allowing the high-temperature gas to be rapidly cooled, thereby improving the cooling effect and cooling efficiency.

Furthermore, the presence of the liquid channel 12, on one hand, ensures that the outer pipe temperature of the pipe structure 10 is relatively safe, as the outer wall temperature cannot be higher than the boiling point of water. On the other hand, the presence of the liquid channel 12 lowers the inner pipe temperature of the pipe structure 10, allowing the material of the pipe structure 10 to be conventional stainless-steel, without the need for special heat-resistant materials, thereby reducing the manufacturing cost of the pipe structure 10 and ensuring the sealing characteristics of the pipe structure 10 to prevent liquid leakage.

It should be additionally noted that, in the present disclosure, there can be only one connection pipe 50, or there can be multiple connection pipes 50. When there are multiple connection pipes 50, the multiple connection tubes 50 can be spaced apart from each other along the axial direction of the pipe structure 10, or spaced apart from each other along the circumferential direction of the pipe structure 10. Multiple connection pipes 50 can also be arranged in multiple rings along the axial direction of the pipe structure 10, with each ring including connection pipes 50 spaced apart from each other along the circumferential direction of the pipe structure 10. Thus, in actual use, the arrangement of the connection pipes 50 can be selected according to actual needs, as long as a good cooling effect is ensured.

In some specific embodiments, the gas flow channel 11 is arranged at an incline, and the gas inlet end 114 is higher than the gas outlet end 115. It can be understood that the inclined arrangement of the gas flow channel 11 allows the liquid channel 12 located external to the gas flow channel 11 to also be inclined. The gas inlet end 114 being higher than the gas outlet end 115 can prevent backflow of the liquid in the liquid channel 12.

In some specific embodiments, as shown in FIG. 5 to FIG. 8, the connection pipe 50 includes a first pipe body 51 and a second pipe body 52. The first pipe body 51 is in communication with the liquid channel 12, and the second pipe body 52 is in communication with the gas flow channel 11. A connection position between the first pipe body 51 and the second pipe body 52 is higher than the gas inlet end 114 of the gas flow channel 11.

It can be understood that the connection pipe 50 including the first pipe body 51 and the second pipe body 52 facilitates the connection of the connection pipe 50 to the liquid storage chamber 122 and the gas flow channel. The fact that the connection point between the first pipe body 51 and the second pipe body 52 is higher than the gas inlet end 114 of the gas flow channel 11 can, to some extent, increase the pressure of the liquid sprayed from the second pipe body 52, increase the total amount of liquid, thereby increasing the contact between the high-temperature gas and the liquid, and accelerating the cooling efficiency.

In some embodiments, the connection pipe 50 further includes a third pipe body 53. One end of the third pipe body 53 is connected to the first pipe body 51 and the other end of the third pipe body 53 is connected to the second pipe body 52, and the third pipe body 53 is higher than the gas inlet end 114 of the gas flow channel 11. It can be understood that the highest point (i.e., the position of the third pipe body 53) of the connection pipe 50 is higher than the highest point (i.e., the gas inlet end 114) of the pipe structure 10. When the liquid passes through the pipe structure 10, since the highest point of the U-shaped pipe is higher than the highest point of the pipe structure 10, it ensures that the liquid fills the pipe structure 10 and can be stably sprayed into the gas flow channel 11, thereby ensuring the cooling effect.

In some specific embodiments, as shown in FIG. 5, the third pipe body 53 is arranged horizontally, and the first pipe body 51 and the second pipe body 52 are each perpendicular to the third pipe body 53. This ensures that the liquid fills the multi-layer pipe structure and can be stably sprayed into the gas flow channel 11, thereby ensuring the cooling effect. Of course, in other embodiments of the present disclosure, an angle between the first pipe body 51 and the second pipe body 52, and an angle between the third pipe body 53and the second pipe body 52 can be selected according to actual needs and is not limited to the limitation of this embodiment.

In some specific embodiments, the connection pipe 50 is a bent pipe. An inlet of the bent pipe is in communication with the liquid channel 12, an outlet of the bent pipe is in communication with the gas flow channel 11, and a bent portion of the bent pipe is higher than the gas inlet end 114 of the gas flow channel 11. It can be understood that the highest point (i.e., the bent portion) of the connection pipe 50 is higher than the highest point (i.e., the gas inlet end 114) of the pipe structure 10. When the liquid passes through the pipe structure 10, because the highest point of the connection pipe 50 is higher than the highest point of the pipe structure 10, it ensures that the liquid fills the pipe structure 10 and can be stably sprayed into the gas flow channel 11, thereby ensuring the cooling effect. At the same time, manufacturing the connection pipe 50 by bending a straight pipe facilitates the manufacturing of the connection pipe 50.

In other embodiments, the connection pipe 50 is a straight pipe. An inlet of the straight pipe is in communication with the liquid channel 12, and an outlet of the straight pipe is in communication with the gas flow channel 11. That is, in the embodiments of the present disclosure, the connection pipe 50 is not limited to the U-shaped pipe structure described previously.

In some embodiments, the gas flow channel 11 includes a high-temperature zone (not shown), which is located at an end of the gas flow channel 11 close to the inflow direction of the high-temperature gas. The liquid channel 12 can further include a cooling channel (not shown) and a liquid storage chamber (not shown). The liquid inlet 1211 is arranged in the cooling channel, the liquid inlet 1211 is connected to an external liquid source, and the cooling channel is located outside the high-temperature zone. The liquid storage chamber has a communication port and the liquid spraying part 13. The communication port is in communication with the cooling channel, and the flow area of the communication port is less than the flow area of the cooling channel and the liquid storage chamber. For example, the communication port of the liquid storage chamber is in communication with the connection pipe 50 to obtain cooling liquid from the cooling channel through the connection pipe 50.

It can be understood that when the high-temperature gas flows through the high-temperature zone, it can be cooled by the cooling liquid in the cooling channel, which allows for cooling of the high-temperature gas through heat exchange and is beneficial for improving the cooling rate. The cooling liquid enters the liquid storage chamber from the cooling channel before being sprayed. Since the flow area of the communication port is less than the flow area of the cooling channel and the liquid storage chamber, the cooling liquid can have a greater pressure after entering the liquid storage chamber, causing the liquid sprayed to the gas flow channel 11 through the liquid spraying part 13 to have a higher pressure.

In some specific embodiments, the number of the liquid spraying parts 13 is multiple, and the liquid spraying parts 13 are spaced apart from each other along the circumferential direction of the gas flow channel 11. It can be understood that the multiple liquid spraying parts 13 being spaced apart from each other along the circumferential direction of the gas flow channel 11 allows the liquid to be uniformly sprayed into the gas flow channel 11, which is beneficial for increasing the contact area between the high-temperature gas and the liquid, thereby improving the cooling rate.

In some specific embodiments, as shown in FIG. 1 and FIG. 5, the gas cooling apparatus 100 further includes a fan 60. The fan 60 is connected to the gas outlet end 115 of the gas flow channel 11. The fan 60 is configured for driving forced flow of the gas within the gas flow channel 11. It can be understood that the fan 60 can drive the gas flow within the gas flow channel 11, thereby increasing the gas flow velocity within the gas flow channel 11, which is beneficial for improving cooling efficiency.

In some specific embodiments, as shown in FIG. 1 and FIG. 5, the gas cooling apparatus 100 further includes a suction pipe 70. One end of the suction pipe 70 is connected to the gas outlet end 115 of the gas flow channel 11, and another end of the suction pipe 70 is configured for installing the fan 60. The end of the suction pipe 70 configured for installing the fan 60 is installed is lower than the end of the suction pipe 70 connected to the gas outlet end 115 of the gas flow channel 11. It can be understood that the fan 60 is connected to the gas outlet end 115 of the gas flow channel 11 through the suction pipe 70, which can ensure that the gas has reached a lower temperature by the time the gas reaches the fan 60, thereby avoiding corrosion of the fan 60 due to relatively high gas temperatures and extending the service life of the fan 60.

In some more specific embodiments, as shown in FIG. 1 and FIG. 5, the gas cooling apparatus 100 further includes an exhaust duct 80. The exhaust duct 80 is connected to a side of the fan 60 away from the suction pipe 70. It can be understood that the added exhaust duct 80 allows for exhausting gas to a designated location. When harmful gases are present in the high-temperature gas, the harmful gases can be discharged into a designated space, improving operational safety.

An embodiment of the present disclosure also provides a heat furnace 1, as shown in FIG. 9. The heat furnace 1 includes a furnace body 200 and the gas cooling apparatus 100 described above. The furnace body 200 has a discharge pipe. The gas cooling apparatus 100 is configured for cooling the gas released from the furnace body 200 through the discharge pipe. It can be understood that in actual use, the pipe structure 10 is connected to the discharge pipe of the heat furnace 1. After the high-temperature gas enters the gas flow channel 11, since the liquid channel 12 is arranged outside the gas flow channel 11, the liquid channel 12 can cool the high-temperature gas. The liquid in the liquid channel 12 can also be sprayed from the liquid spraying part 13 to the gas flow channel 11. The sprayed liquid will rapidly atomize upon encountering the high-pressure gas sprayed from the gas spraying part 14. The atomized liquid will then mix with the high-temperature gas. Upon encountering the high-temperature gas, the atomized liquid rapidly vaporizes, turning into steam. When the liquid vaporizes, a large amount of heat is absorbed, thereby ensuring that the temperature of the high-temperature gas drops rapidly, and the high-temperature gas will have a lower temperature when discharged from the conduit structure 10.

Compared to the existing technical solutions of wrapping cold-water pipes around an exhaust pipeline, the pipe structure 10 of the present disclosure is connected to the gas outlet of the exhaust pipeline (e.g., exhaust duct 80), is simple to use, is not easily damaged by the exhaust pipeline, ensuring a long service life. During operation, a large amount of heat can be carried away through liquid cooling and liquid vaporization, achieving rapid cooling of the high-temperature gas and improving the cooling rate and cooling efficiency. The provision of the gas spraying part 14, which can spray high-pressure gas to the gas flow channel 11 to atomize the liquid sprayed into the gas flow channel 11, allows for full utilization of the sprayed liquid for cooling the high-temperature gas, reducing the amount of sprayed liquid used.

It should be additionally noted that because the liquid channel 12 is arranged outside the gas flow channel 11, the presence of the liquid channel 12 on one hand can ensure that the outer pipe temperature of the pipe structure 10 is relatively safe, as the outer wall temperature cannot be higher than the boiling point of water. On the other hand, the presence of the liquid channel 12 lowers the inner pipe temperature of the pipe structure 10, allowing the material of the pipe structure 10 to be conventional stainless-steel, without the need for special heat-resistant materials, thereby reducing the manufacturing cost of the gas cooling apparatus 100 and ensuring the sealing characteristics of the gas cooling apparatus 100 to prevent liquid leakage.

The foregoing descriptions are only preferred embodiments of the present disclosure and are not intended to limit the present disclosure. Any modifications, equivalent substitutions, and improvements made within the spirit and principles of the present disclosure shall be included within the protection scope of the present disclosure.

What is claimed is:

1. A gas cooling apparatus comprising a pipe structure comprising a gas flow channel and a liquid channel, wherein the gas flow channel is configured for circulating a gas at a high temperature, the liquid channel is located outside the gas flow channel and comprises a liquid spraying part in communication with the gas flow channel, the pipe structure further comprises at least one gas spraying part communicated with the gas flow channel and configured to spay the gas in the gas flow channel in a high pressure, wherein the gas cooling apparatus is configured to vaporize liquid sprayed from the liquid spraying part by the gas circulating in the gas flow channel and the gas sprayed from the gas spraying part.

2. A gas cooling apparatus comprising a pipe structure comprising a gas flow channel and a liquid channel, wherein the gas flow channel is configured for circulating a gas at a high temperature, the liquid channel is located outside the gas flow channel and comprises a liquid spraying part in communication with the gas flow channel, and the liquid spraying part is configured for spraying liquid to the gas flow channel.

3. The gas cooling apparatus according to claim 1, wherein the gas flow channel comprises a high-temperature zone located at an end of the gas flow channel close to an inflow direction of the gas in the gas flow channel; and
the liquid channel comprises:
a cooling channel located outside the high-temperature zone and comprising a liquid inlet connectable to an external liquid source.

4. The gas cooling apparatus according to claim 3, further comprising a liquid inlet pipe, wherein one end of the liquid inlet pipe is connected to the pipe structure and is in communication with the liquid inlet, and another end of the liquid inlet pipe is connectable to the external liquid source.

5. The gas cooling apparatus according to claim 4, further comprising a guide pipe located within the cooling channel, and configured to regulate liquid in the cooling channel such that the cooling channel is substantially filled with the liquid before the liquid overflowing into a liquid storage chamber;
the liquid channel further comprises the liquid storage chamber comprising a communication port and the liquid spraying part, wherein the communication port is in communication with the cooling channel, and a flow area of the communication port is less than a flow area of each of the cooling channel and the liquid storage chamber.

6. The gas cooling apparatus according to claim 5, wherein an inlet of the guide pipe is in communication with the cooling channel, the inlet of the guide pipe is located at a gas inlet end of the gas flow channel, and an outlet of the guide pipe is in communication with the liquid storage chamber, a flow path of the liquid flows from the cooling channel flows into the liquid storage chamber via the guide pipe.

7. The gas cooling apparatus according to claim 5, wherein the guide pipe comprises a first pipe section and a second pipe section, the first pipe section is in communication with the liquid channel, the second pipe section is in communication with the liquid storage chamber, and a connection position between the first pipe section and the second pipe section is gravitationally higher than a gas inlet end of the gas flow channel.

8. The gas cooling apparatus according to claim 5, wherein the guide pipe is a bent pipe, an inlet of the bent pipe is in communication with the liquid channel, an outlet of the bent pipe is in communication with the liquid storage chamber, and a bent portion of the bent pipe is gravitationally higher than a gas inlet end of the gas flow channel.

9. The gas cooling apparatus according to claim 1, wherein an extension direction of the liquid spraying part intersects with an extension direction of the gas spraying part.

10. The gas cooling apparatus according to claim 9, wherein the pipe structure further comprises a gas storage chamber connectable to an external gas source, and the gas spraying part is in communication with the gas storage chamber;
along a gas flow direction within the gas flow channel, a flow area of the gas storage chamber gradually decreases, and the gas spraying part is arranged on an inclined sidewall of the gas storage chamber facing the gas flow channel.

11. The gas cooling apparatus according to claim 10, further comprising a gas inlet pipe, wherein one end of the gas inlet pipe is connected to the gas storage chamber, and another end of the gas inlet pipe is connectable to an external high-pressure gas source.

12. The gas cooling apparatus according to claim 4, wherein a number of the gas spraying part is multiple, and the gas spraying parts are spaced apart from each other along a circumferential direction of the gas flow channel.

13. The gas cooling apparatus according to claim 4, wherein the gas flow channel comprises a gas inlet end and a gas outlet end, the gas inlet end is configured for inflowing the gas at the high temperature, and the liquid channel has a liquid inlet;
the liquid channel further comprises a connection pipe, an outlet of the connection pipe is arranged at the gas outlet end, an inlet of the connection pipe is in communication with the liquid channel, and the outlet of the connection pipe is in communication with the gas flow channel to spray the liquid to the gas flow channel;
wherein the liquid spraying part is arranged at the outlet of the connection pipe, and the outlet of the connection pipe sprays the liquid to the gas flow channel through the liquid spraying part.

14. The gas cooling apparatus according to claim 13, wherein the gas flow channel is inclinedly arranged, and the gas inlet end is gravitationally higher than the gas outlet end.

15. The gas cooling apparatus according to claim 13, wherein the connection pipe comprises a first pipe body and a second pipe body, the first pipe body is in communication with the liquid channel, and the second pipe body is in communication with the gas flow channel.

16. The gas cooling apparatus according to claim 15, wherein the connection pipe further comprises a third pipe body, one end of the third pipe body is connected to the first pipe body, and another end of the third pipe body is connected to the second pipe body; and the third pipe body is gravitationally higher than the gas inlet end of the gas flow channel.

17. The gas cooling apparatus according to claim 13, wherein the connection pipe is a bent pipe, an inlet of the bent pipe is in communication with the liquid channel, an outlet of the bent pipe is in communication with the gas flow channel, and a bent portion of the bent pipe is gravitationally higher than the gas inlet end of the gas flow channel.

18. The gas cooling apparatus according to claim 4, further comprising a fan arranged within the pipe structure and configured to drive forced flow of a gas within the gas flow channel.

19. The gas cooling apparatus according to claim 18, further comprising a suction pipe, wherein one end of the suction pipe is connected to a gas outlet end of the gas flow channel, and another end of the suction pipe is configured for installing the fan, and the end of the suction pipe configured for installing the fan is gravitationally lower than the end of the suction pipe connected to the gas outlet end.

20. The gas cooling apparatus according to claim 19, further comprising an exhaust duct connected to a side of the fan away from the suction pipe.

21. A heat furnace comprising:
a furnace body comprising a discharge pipe; and
the gas cooling apparatus according to claim 1, wherein the gas cooling apparatus is configured for cooling gas released from the furnace body through the discharge pipe.

22. The gas cooling apparatus according to claim 4, wherein the liquid inlet pipe is in communication with the liquid spraying part, and a direction of the liquid sprayed from the liquid spraying part to the gas flow channel is substantially perpendicular to an extending direction of the gas flow channel.

23. The gas cooling apparatus according to claim 4, wherein the liquid inlet pipe is in communication with the liquid spraying part through the cooling channel.

24. The gas cooling apparatus according to claim 4, further comprising a suction pipe inclined relative to a horizontal direction and in communication with the gas flow channel, wherein the liquid spraying part is configured to spray the liquid into the gas flow channel from an upper side of the suction pipe.
